(19) United States
(12) Patent Application Publication
(10) Pub. No.: US 2009/0028056 A1
(43) Pub. Date: Jan. 29, 2009

(54) SYSTEM AND METHOD FOR PREDICTING A FAULT IN A REAL-TIME TRANSPORT PROTOCOL PACKET STREAM

(75) Inventors: MOSHIUR RAHMAN, MARLBORO, NJ (US); ZHI LI, MARTINEZ, CA (US)

Correspondence Address: AKERMAN SENTERFITT, P.O. BOX 3188, WEST PALM BEACH, FL, 33402-3188, US

(73) Assignee: AT&T KNOWLEDGE VENTURES, L.P., RENO, NV (US)

(21) Appl. No.: 11/828,618

(22) Filed: Jul. 26, 2007

(51) Int. Cl. H04L 12/56

(52) U.S. Cl. 370/242; 370/390

(57) ABSTRACT

A system that incorporates teachings of the present disclosure may include, for example, a monitoring system having a controller element to predict a fault in a video stream of real-time transport protocol (RTP) packets according to gaps in sequence numbers of said RTP packets. Other embodiments are disclosed.

### FIELD OF THE DISCLOSURE

The present disclosure relates generally to communication services and more specifically to a system and method for predicting a fault in a real-time transport protocol packet stream.

### BACKGROUND

As consumers migrate to the Internet for voice and video services, the stability of an audio or video communication session becomes a critical factor in the quality of service provided to the consumer. To accommodate voice and video communications over the Internet, a protocol known as a real-time transport protocol (RTP) is used to produce virtual continuous streams of packets between communication devices. RTP adds timing and sequence information to each packet to allow the reassembly of packets to reproduce real-time audio and video information.

Notwithstanding efforts to provide stable voice and video services over the Internet using RTP, the dynamic switching nature of network elements in a packet-switched network as well as other factors such as an unexpected data surge that can occur in such networks can cause a number of network elements to interrupt an RTP stream. As the level of interruption increases, the distortion of audio and video signals becomes more apparent to subscribers of voice and video services such as Voice over IP (VoIP) and Internet Protocol Television (IPTV). Without a mitigation scheme to protect against such distortions, migration of consumers from a public switched network (PSTN) to IP-based voice, video and data services may be hampered.

### BRIEF DESCRIPTION OF THE DRAWINGS

FIGS. 1-2 depicts an exemplary embodiment of a communication system;

FIG. 3 depicts an exemplary method operating in portions of the communication system; and

FIG. 4 is a diagrammatic representation of a machine in the form of a computer system within which a set of instructions, when executed, may cause the machine to perform any one or more of the methodologies discussed herein.

### DETAILED DESCRIPTION

In one embodiment of the present disclosure, a computer-readable storage medium can have computer instructions for selecting a stream of real-time transport protocol (RTP) packets associated with an Internet protocol television (IPTV) multicast communication session, monitoring the stream of RTP packets for gaps in their sequence numbers, comparing a historical collection of said gaps to a threshold, predicting from said comparison a fault in at least a portion of the multicast communication session, and submitting a notice associated with said fault.

In one embodiment of the present disclosure, a monitoring system can have a controller element to predict a fault in a video stream of RTP packets according to gaps in sequence numbers of said RTP packets.

In one embodiment of the present disclosure, a method can involve monitoring gaps in sequence numbers of a stream of RTP packets, and predicting a fault in the stream of RTP packets according to said monitoring step.

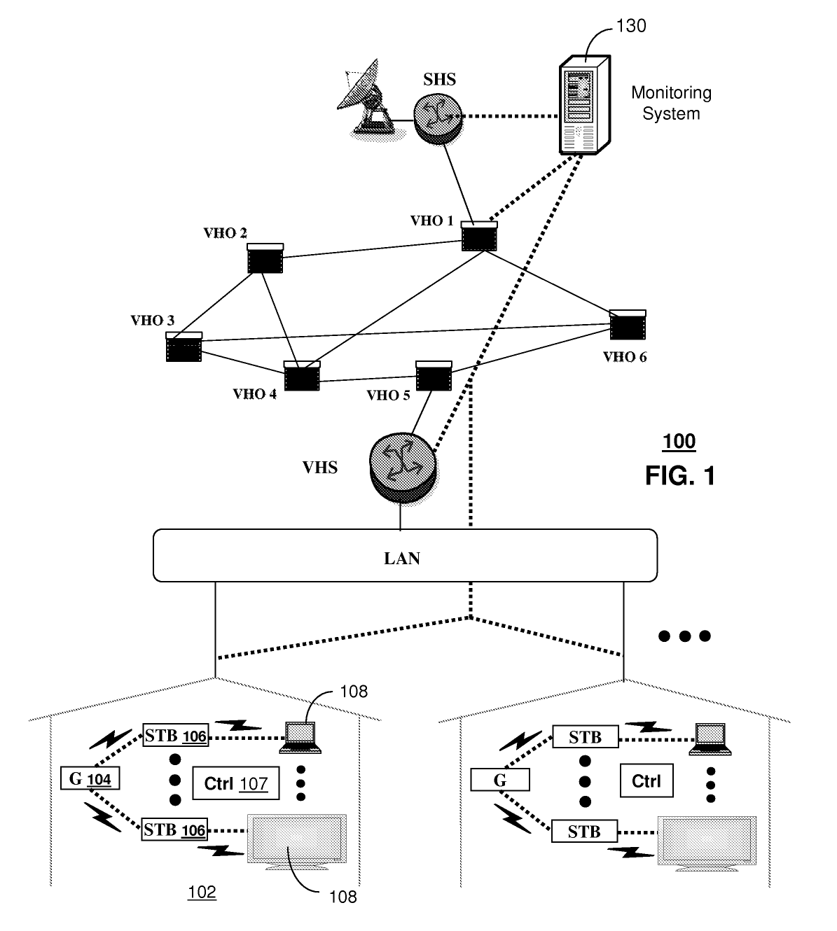

FIG. 1 depicts an exemplary embodiment of a communication system 100 employing an IPTV broadcast media architecture. In a typical IPTV infrastructure, there is at least one super head office server (SHS) which receives national media programs from satellite and/or media servers from service providers of multimedia broadcast channels. The SHS server forwards IP packets associated with the media content to video head servers (VHS) via a network of video head offices (VHO) according to a common multicast communication method. The VHS then distributes multimedia broadcast programs to commercial and/or residential buildings 102 housing a gateway 104 (e.g., a residential gateway or RG). The gateway 104 distributes broadcast signals to media receivers 106 such as Set-Top Boxes (STBs) which in turn present broadcast selections to media devices 108 such as computers or television units managed in some instances by a media controller 107 (e.g., an infrared or RF remote control). Unicast traffic can also be exchanged between the media receivers 106 and subsystems of the IPTV media system 100 for services such as video-on-demand (VoD).

A monitoring system 130 utilizing common computing and communication technologies can be coupled to one or more of the sub-network elements of the IPTV system to monitor RTP streams of unicast and multicast communication sessions.

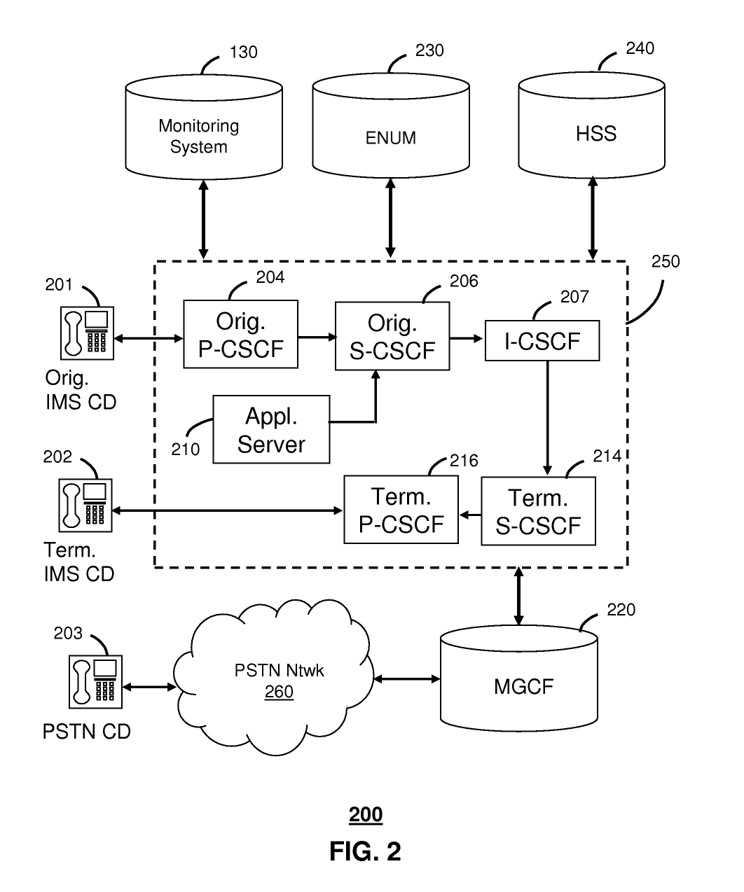

FIG. 2 depicts an exemplary embodiment of a communication system 200 employing a IP Multimedia Subsystem (IMS) network architecture. Communication system 200 can be overlaid or operably coupled with communication system 100 as another representative embodiment of communication system 100.

The communication 200 can comprise a Home Subscriber Server (HSS) 240, a tElephone NUmber Mapping (ENUM) server 230, and network elements of an IMS network 250. The IMS network 250 can be coupled to IMS compliant communication devices (CD) 201, 202 or a Public Switched Telephone Network (PSTN) CD 203 using a Media Gateway Control Function (MGCF) 220 that connects the call through a common PSTN network 260.

IMS CDs 201, 202 register with the IMS network 250 by contacting a Proxy Call Session Control Function (P-CSCF) which communicates with a corresponding Serving CSCF (S-CSCF) to register the CDs with an Authentication, Authorization and Accounting (AAA) support by the HSS 240. To accomplish a communication session between CDs, an originating IMS CD 201 can submit a SIP INVITE message to an originating P-CSCF 204 which communicates with a corresponding originating S-CSCF 206. The originating S-CSCF 206 can submit the SIP INVITE message to an application server (AS) such as reference 210 that can provide a variety of services to IMS subscribers. For example, the application server 115 can be used to perform originating treatment functions on the calling party number received by the originating S-CSCF 206 in the SIP INVITE message.

Originating treatment functions can include determining whether the calling party number has international calling services, and/or is requesting special telephony features (e.g., *72 forward calls, *73 cancel call forwarding, *67 for caller ID blocking, and so on). Additionally, the originating SCSCF 206 can submit queries to the ENUM system 230 to translate an E.164 telephone number to a SIP Uniform Resource Identifier (URI) if the targeted communication device is IMS compliant. If the targeted communication device is a PSTN device, the ENUM system 230 will respond with an unsuccessful address resolution and the S-CSCF 206 will forward the call to the MGCF 220 via a Breakout Gateway Control Function (not shown).

When the ENUM server 230 returns a SIP URI, the SIP URI is used by an Interrogating CSCF (I-CSCF) 207 to submit a query to the HSS 240 to identify a terminating S-CSCF 214 associated with a terminating IMS CD such as reference 202. Once identified, the I-CSCF 207 can submit the SIP INVITE to the terminating S-CSCF 214 which can call on an application server similar to reference 210 to perform the originating treatment telephony functions described earlier. The terminating S-CSCF 214 can then identify a terminating P-CSCF 216 associated with the terminating CD 202. The P-CSCF 216 then signals the CD 202 to establish communications. The aforementioned process is symmetrical. Accordingly, the terms “originating” and “terminating” in FIG. 2 can be interchanged.

The IMS network 250 can also be coupled to the monitoring system 130 previously described in FIG. 1. In this context, the monitoring system 130 can be utilized to monitor RTP packet streams associated with Voice over IP (VoIP) communication sessions.

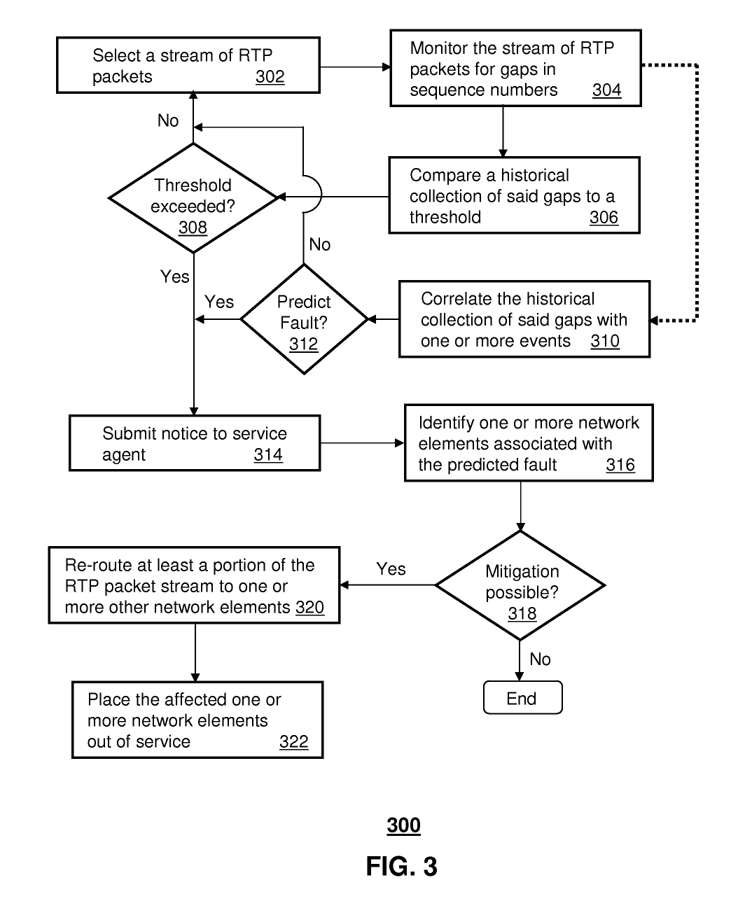

FIG. 3 depicts an exemplary method 300 operating in portions of the communication systems 100-200. For convenience, the term communication system 100 as used in the following paragraphs can mean communication systems 100 and 200 singly or in combination. Method 300 begins with step 302 in which the monitoring system 130 is programmed to select a stream of RTP packets to monitor. The monitoring system 130 can be programmed to randomly select RTP streams at various network elements of communication system 100. Alternatively or in combination the monitoring system 130 can be programmed to select an RTP stream according to a predetermined pattern configured by a service provider of communication system 100 to monitor the performance of network elements operating in said system.

The monitoring system 130 can select any network element in the path of an RTP stream of packets. For example, the stream can be monitored at or near the source of RTP packets, at or near one or more end points (e.g., an STB), or any where else in between (e.g., VHO servers, VHS, network routers, Digital Subscriber Line Access Multiplexer (DSLAM) of a central office, service area interface (SAI) serving a plurality of subscribers, a residential gateway 104 of a select subscriber, the LAN between buildings 102, etc.). In the case of multicast communications, RTP streams flowing through multiple network elements can be monitored. Accordingly, the number of network elements monitored can vary depending on the type of stream under analysis. As a reminder, the monitoring system 130 can monitor any RTP stream including audio (e.g., VoIP, streaming audio) and video (e.g., IPTV). Accordingly, the monitoring process described in method 300 can be applied to real-time video and/or audio media applications.

With this in mind, the monitoring system 130 proceeds to step 304 where it begins to monitor the selected stream of RTP packets for gaps in their sequence numbers. Sequence number gaps can be due to any anomalous condition experienced by network elements of communication systems 100 (e.g., buffer overruns, burst errors, excessive noise, jitter, faulty routers, etc.). Based on telemetry data associated with sequence numbers collected in step 304 from one or more network elements, the monitoring system 130 can be programmed to compare in step 306 a historical collection of detected gaps to a threshold.

For instance, the monitoring system 130 can monitor a historical running average of detected gaps. If the running average of gaps exceeds a given threshold in step 308 the monitoring system 130 proceeds to step 314 where it submits a notice to a service agent indicating that a fault is predicted for the RTP stream under review. The threshold can be selected by the service provider of the audio and/or video service under analysis based on Quality of Service (QoS) criteria, a service level agreement (SLA) with the subscriber, or some other common performance metric suitable for the present disclosure. If the threshold is not exceeded, the monitoring system 130 repeats steps 302-306 to continue the monitoring process on the same or a different stream of RTP packets (depending on the selection algorithm used).

Alternatively, or in combination, the monitoring system 130 can be programmed to utilize correlation techniques such as linear regression to predict a fault based on detected gaps and events occurring in portions of the communication system 100. For instance, the monitoring system 130 can be programmed to detect that a select one or more routers in communication system 100 have a packet traffic overload condition which can be correlated to events taking place with downstream routers receiving the stream of RTP packets from said router. Based on correlation results derived from an example such as this, the monitoring system 130 can predict in step 312 a fault having a particular likelihood of adversely affecting audio and/or video services of one or more subscribers. In this embodiment, a fault prediction can be triggered by a confidence level generated by the prediction model used in step 310. For example, a confidence level of 90% may be sufficient for the monitoring system 130 to proceed to step 314 where it notifies a service agent of the predicted fault.

The notice generated in step 314 can be in the form of a field repair service request (often referred to in telecommunications parlance as a repair ticket). The repair ticket can be supplemented with telemetry information collected in steps 306 or 310 and information in step 316 where the monitoring system 130 identifies one or more network elements associated with the predicted fault. The affected network elements can be identified by common techniques. For instance, the monitoring system 130 can be programmed to trace through network elements conveying the stream of RTP packets to determine where gaps are prominent and where the stream is unaffected. Once the affected point in the stream is found, the network elements near said points can be identified to the field repair agent notified in step 314.

In another embodiment, the monitoring system 130 can be programmed in step 318 to determine whether there is a means to mitigate said fault before it affects one or more subscribers. Mitigation can be possible in cases where the affected portion of the stream of RTP packets can be re-routed through other network elements of the communication system 100 without adversely affecting subscribers. If this is not possible, method 300 ends and is repeated for other streams to be monitored. If mitigation is possible, the monitoring system 130 proceeds to step 320 where it re-route the affected portion of RTP packets to one or more other network elements of the communication system 100. Once this is accomplished, the affected network elements are placed out of service in step 322 by the monitoring system 130 until field repair personnel indicate that said elements can be reinstated to service.

Upon reviewing the aforementioned embodiments, it would be evident to an artisan with ordinary skill in the art that said embodiments can be modified, reduced, or enhanced without departing from the scope and spirit of the claims described below. For example, it would be evident to said artisan of ordinary skill that other methods for predicting faults can be applied to the present disclosure. Additionally, the frequency of monitoring, and the number of RTP packet streams monitored can vary depending on the resources of the monitoring system 130. In another embodiment, portions of method 300 can be distributed in communication system 100. In this instance, network elements can perform in whole or in part self-monitoring techniques based on method 300. Monitoring results can be communicated by each network element to a central monitoring system that aggregates, processes, and determines when notification and evasive action may be necessary.

These are but a few examples of modifications that can be applied to the present disclosure without departing from the scope of the claims. Accordingly, the reader is directed to the claims section for a fuller understanding of the breadth and scope of the present disclosure.

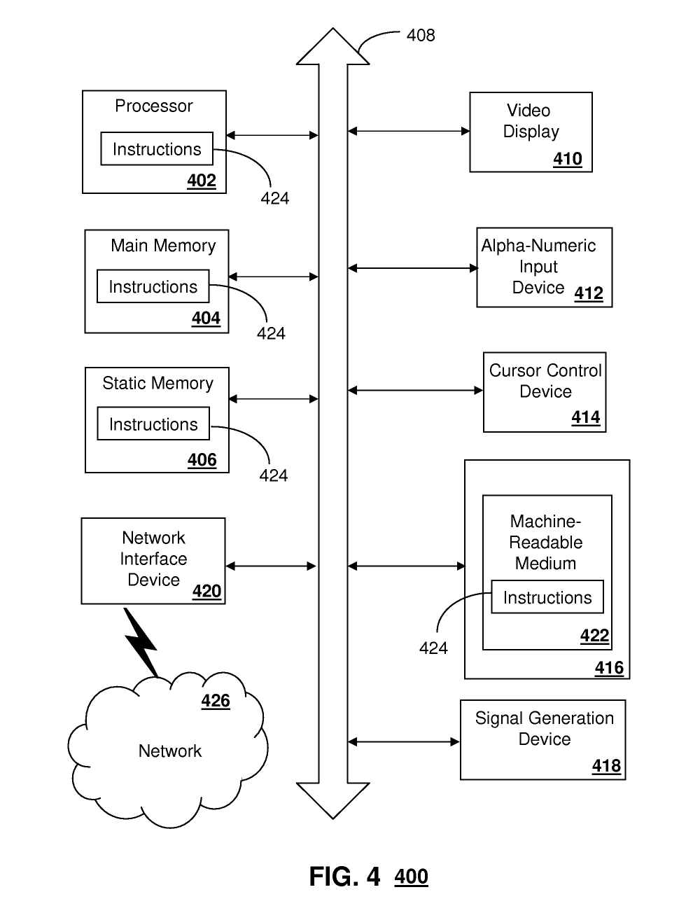

FIG. 4 depicts an exemplary diagrammatic representation of a machine in the form of a computer system 400 within which a set of instructions, when executed, may cause the machine to perform any one or more of the methodologies discussed above. In some embodiments, the machine operates as a standalone device. In some embodiments, the machine may be connected (e.g., using a network) to other machines. In a networked deployment, the machine may operate in the capacity of a server or a client user machine in server-client user network environment, or as a peer machine in a peer-to-peer (or distributed) network environment.

The machine may comprise a server computer, a client user computer, a personal computer (PC), a tablet PC, a laptop computer, a desktop computer, a control system, a network router, switch or bridge, or any machine capable of executing a set of instructions (sequential or otherwise) that specify actions to be taken by that machine. It will be understood that a device of the present disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methodologies discussed herein.

The computer system 400 may include a processor 402 (e.g., a central processing unit (CPU), a graphics processing unit (GPU, or both), a main memory 404 and a static memory 406, which communicate with each other via a bus 408. The computer system 400 may further include a video display unit 410 (e.g., a liquid crystal display (LCD), a flat panel, a solid state display, or a cathode ray tube (CRT)). The computer system 400 may include an input device 412 (e.g., a keyboard), a cursor control device 414 (e.g., a mouse), a mass storage medium 416, a signal generation device 418 (e.g., a speaker or remote control) and a network interface device 420.

The mass storage medium 416 may include a computer-readable storage medium 422 on which is stored one or more sets of instructions (e.g., software 424) embodying any one or more of the methodologies or functions described herein, including those methods illustrated above. The computer-readable storage medium 422 can be an electromechanical medium such as a common disk drive, or a mass storage medium with no moving parts such as Flash or like non-volatile memories. The instructions 424 may also reside, completely or at least partially, within the main memory 404, the static memory 406, and/or within the processor 402 during execution thereof by the computer system 400. The main memory 404 and the processor 402 also may constitute computer-readable storage media.

Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present disclosure contemplates a machine readable medium containing instructions 424, or that which receives and executes instructions 424 from a propagated signal so that a device connected to a network environment 426 can send or receive voice, video or data, and to communicate over the network 426 using the instructions 424. The instructions 424 may further be transmitted or received over a network 426 via the network interface device 420.

While the computer-readable storage medium 422 is shown in an example embodiment to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present disclosure.

The term “computer-readable storage medium” shall accordingly be taken to include, but not be limited to: solid-state memories such as a memory card or other package that houses one or more read-only (non-volatile) memories, random access memories, or other re-writable (volatile) memories; magneto-optical or optical medium such as a disk or tape; and carrier wave signals such as a signal embodying computer instructions in a transmission medium; and/or a digital file attachment to e-mail or other self-contained information archive or set of archives is considered a distribution medium equivalent to a tangible storage medium. Accordingly, the disclosure is considered to include any one or more of a computer-readable storage medium or a distribution medium, as listed herein and including art-recognized equivalents and successor media, in which the software implementations herein are stored.

Although the present specification describes components and functions implemented in the embodiments with reference to particular standards and protocols, the disclosure is not limited to such standards and protocols. Each of the standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same functions are considered equivalents.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A computer-readable storage medium, comprising computer instructions for:
selecting a stream of real-time transport protocol (RTP) packets associated with an Internet protocol television (IPTV) multicast communication session;
monitoring the stream of RTP packets for gaps in their sequence numbers;
comparing a historical collection of said gaps to a threshold;
predicting from said comparison a fault in at least a portion of the multicast communication session; and
submitting a notice associated with said fault.

2. The storage medium of claim 1, comprising computer instructions for submitting said notice to a service agent of an IPTV communication system.

3. The storage medium of claim 2, wherein the notice comprises a field repair service request, and wherein the threshold is determined from a service level agreement.

4. The storage medium of claim 1, comprising computer instructions for re-routing at least a portion of the IPTV multicast communication session to circumvent the predicted fault.

5. The storage medium of claim 1, comprising computer instructions for correlating the historical collection of said gaps with one or more events to predict the fault.

6. The storage medium of claim 1, comprising computer instructions for identifying a network element of an IPTV communication system as a source of the fault.

7. The storage medium of claim 6, comprising computer instructions for:
re-routing at least a portion of the IPTV multicast communication session to another network element of the IPTV communication system; and
placing the identified network element out of service.

8. The storage medium of claim 6, wherein the identified network element comprises at least a portion of at least one among a video head office (VHO) server, a video head server (VHS), a local area network (LAN), a Digital Subscriber Line Access Multiplexer (DSLAM), a service area interface (SAI), and a gateway.

9. A monitoring system, comprising a controller element to predict a fault in a video stream of real-time transport protocol (RTP) packets according to gaps in sequence numbers of said RTP packets.

10. The monitoring system of claim 9, wherein the controller element:
compares a historical collection of said gaps to a threshold;
predicts from said comparison a fault in the video stream; and
submits a notice associated with said fault.

11. The monitoring system of claim 9, wherein the controller element submits said notice to a service agent of an IPTV communication system.

12. The monitoring system of claim 9, wherein the video stream corresponds to a multicast video broadcast stream, and wherein the controller re-routes at least a portion of the multicast video broadcast stream to circumvent a network element associated with the predicted fault.

13. The monitoring system of claim 9, wherein the controller element correlates a historical collection of said gaps to predict the fault.

14. The monitoring system of claim 9, wherein the controller element identifies a network element of an IPTV communication system as a source of the fault.

15. The monitoring system of claim 14, wherein the controller element:
re-routes at least a portion of the video stream to another network element of the IPTV communication system; and
places the identified network element out of service.

16. The monitoring system of claim 14, wherein the network element comprises at least a portion of at least one among a video head office (VHO) server, a video head server (VHS), a local area network (LAN), a Digital Subscriber Line Access Multiplexer (DSLAM), a service area interface (SAI), and a gateway.

17. A method, comprising:
monitoring gaps in sequence numbers of a stream of real-time transport protocol (RTP) packets; and
predicting a fault in the stream of RTP packets according to said monitoring step.

18. The method of claim 17, wherein the stream comprises at least one among a Voice over IP (VoIP) packets and video packets.

19. The method of claim 17, comprising predicting the fault from a correlation of a historical collection of said gaps.

20. The method of claim 17, comprising re-routing at least a portion of the stream of RTP packets in a packet-switched communication system to mitigate one or more network elements associated with the predicted fault.
